(19) United States
(12) Patent Application Publication
(10) Pub. No.: US 2018/0058137 A1
(43) Pub. Date: Mar. 1, 2018

(54) An Elongate Profiled Frame Element

(71) Applicant: Deceuninck NV, Hooglede-Gits (BE)

(72) Inventors: Erik De Maeyer, Hooglede-Gits (BE); Peter Degrande, Hooglede-Gits (BE)

(21) Appl. No.: 15/557,038

(22) PCT Filed: Mar. 9, 2016
(86) PCT No.: PCT/EP2016/055038

§ 371 Date: Sep. 8, 2017

(30) Foreign Application Priority Data
Mar. 9, 2015 (EP) 15158265.7

(51) Int. Cl. E06B 3/22; E06B 3/58

(52) U.S. Cl. CPC E06B 3/222; E06B 2003/26332; E06B 2003/224; E06B 3/5842

(57) ABSTRACT

The present invention is directed to a construction profile for a window or door frame, the profile manufactured in a plastics material and comprising: —a main body extending in a longitudinal direction X; —one fixed and one removable clamping bracket, both clamping brackets protruding from said main body in direction Y perpendicular to the longitudinal direction X, and extending parallel to one another and at a distance of one another in the longitudinal direction X; —a pane receiving zone defined by, on the one hand, said clamping brackets and, on the other hand, a surface of said main body, the receiving zone configured to receive a side edge of a pane (the pane extending in the X-Y plane) to be clamped between said clamping brackets, —the fixed clamping bracket comprising a hollow body having at least two side walls, one facing the pane receiving zone and one facing away the pane receiving zone and defining an upper free end portion (configured to abut a pane received in the pane receiving zone) and a base portion joining the upper free end portion to the main body, characterized in that the distance between said side walls of the fixed clamping bracket progressively widens at its base portion from the upper portion towards the main body. Further, the present invention is also directed to a window or door comprising a frame with at least one construction profile as defined above, the window or door having a Resistance Class RC 2 N according to the DIN V ENV 1627/2011 standard.

### FIELD OF THE INVENTION

The present invention relates to a construction profile for a window or door frame, the profile manufactured in a plastics material. In addition, it relates a window or door comprising a frame with at least one such construction profile.

### BACKGROUND

State-of-the-art plastic window assemblies comprise a frame formed from a number of elongate plastic construction profiles connected together at the corners of the frame. Such construction profile is shaped to provide a receiving zone for receiving a marginal portion of a side edge of a pane and two clamping brackets engaging on the marginal portions of the pane for securing its position. The clamping brackets may be both fixed being an integral part of the elongate construction profiles. Alternatively, the construction profile may be shaped providing a fixed clamping bracket and a channel for receiving a removable clamping bracket. After installing the pane in the receiving zone, the removable clamping bracket is mounted in the channel.

An example of a state-of-the-art plastic construction profile shaped providing a fixed clamping bracket and a channel for receiving a removable clamping bracket is described in DE19632048.

As can be seen from FIG. 1, such fixed clamping bracket (PA1) is relatively wide in cross-section (PA2) perpendicular to the X-Y plane. Typical dimensions are 15 to 25 mm. These dimensions are necessary for giving the bracket sufficient strength, in particular for putting sufficient pressure on the pane achieving a waterproof and wind tight connection between the clamping bracket and the pane, also for achieving sufficient thermal stability and mechanical stability, and further for resisting load and torsion load on the bracket caused by wind load on the pane.

It is a general problem that construction profiles having clamping brackets with relatively wide cross-section do not allow the manufacturing of window assemblies with less pronounced construction profiles with respect to the window in its totality, let alone window assemblies meant for being mounted in a (partially) sunken configuration, i.e. with construction profiles that are partially or completely hidden in the wall cavity.

Considering the above, it is an object of the present invention to provide a plastic construction profile having a shallow fixed clamping bracket allowing manufacturing more minimalistic windows yet without jeopardizing strength of the profile and window assembly.

### SHORT DESCRIPTION OF THE DRAWINGS

FIG. 1 illustrates a state-of-the-art plastic construction profile for a window or door frame.

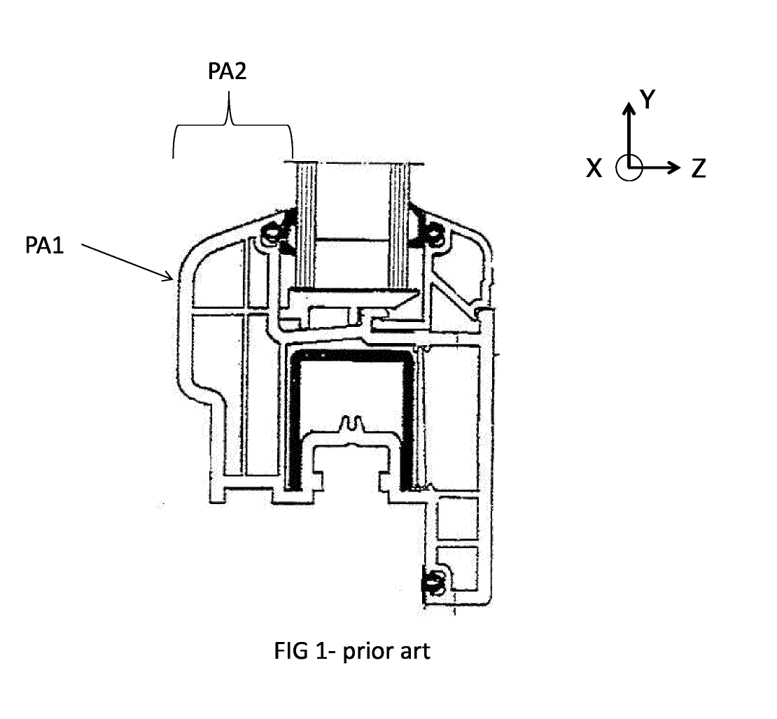

FIG. 2 illustrates an embodiment of a plastic construction profile for a window or door frame in accordance with the present invention.

FIG. 3 provides a detailed view of an embodiment of a plastic construction profile for a window or door frame in accordance with the present invention.

### SUMMARY OF THE INVENTION

The present invention is directed to a construction profile for a window or door frame, the profile manufactured in a plastics material and comprising:
a main body extending in a longitudinal direction X;
one fixed and one removable clamping bracket, both clamping brackets protruding from said main body in direction Y perpendicular to the longitudinal direction X, and extending parallel to one another and at a distance of one another in the longitudinal direction X;
a pane receiving zone defined by, on the one hand, said clamping brackets and, on the other hand, a surface of said main body, the receiving zone configured to receive a side edge of a pane (the pane extending in the X-Y plane) to be clamped between said clamping brackets,
the fixed clamping bracket comprising a hollow body having at least two side walls, one facing the pane receiving zone and one facing away the pane receiving zone and defining an upper free end portion (configured to abut a pane received in the pane receiving zone) and a base portion joining the upper free end portion to the main body,
characterized in that the distance between said side walls of the fixed clamping bracket progressively widens at its base portion from the upper portion towards the main body.

Further, the present invention is also directed to a window or door comprising a frame with at least one construction profile as defined above, the window or door having a Resistance Class RC 2 N according to the DIN V ENV 1627/2011 standard.

### DETAILED DESCRIPTION

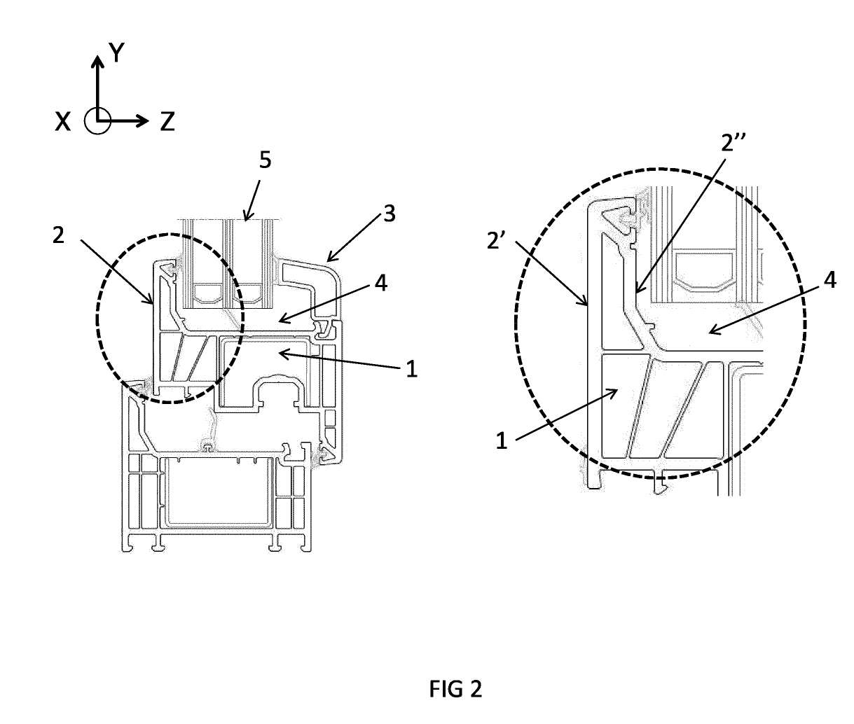

As a first embodiment in accordance with the present invention and as illustrated in FIG. 2, a construction profile for a window or door frame is provided, the profile manufactured in a plastics material and comprising:
a main body (1) extending in a longitudinal direction X;
one fixed (2) and one removable (3) clamping bracket, both clamping brackets protruding from said main body in direction Y perpendicular to the longitudinal direction X, and extending parallel to one another and at a distance of one another in the longitudinal direction X;
a pane receiving zone (4) defined by, on the one hand, said clamping brackets and, on the other hand, a surface of said main body, the receiving zone configured to receive a side edge of a pane (5) (the pane extending in the X-Y plane) to be clamped between said clamping brackets,
the fixed clamping bracket comprising a hollow body having at least two side walls (2′, 2″), one facing the pane receiving zone (2″) and one facing away the pane receiving zone (2′) and defining an upper free end portion (configured to abut a pane received in the pane receiving zone) and a base portion joining the upper free end portion to the main body,
characterized in that the distance between said side walls (2′, 2″) of the fixed clamping bracket progressively widens at its base portion from the upper portion towards the main body (1).

By progressively widening the distance between the sidewalls towards the main body, the fixed clamping bracket may be manufactured with smaller cross-section width, measured perpendicular to the X-Y plane, compared to state of the art plastic construction profiles, while still enabling putting sufficient pressure on the pane for achieving a waterproof and wind tight connection between the clamping bracket and the pane, and still providing sufficient thermal stability and mechanical stability.

In an embodiment, the distance between said side walls (2′, 2″) of the fixed clamping bracket may progressively widen at its base portion from the upper portion towards the main body (1) by extending the side wall facing the pane receiving zone slantingly inwards the pane receiving zone (4) towards that main body surface.

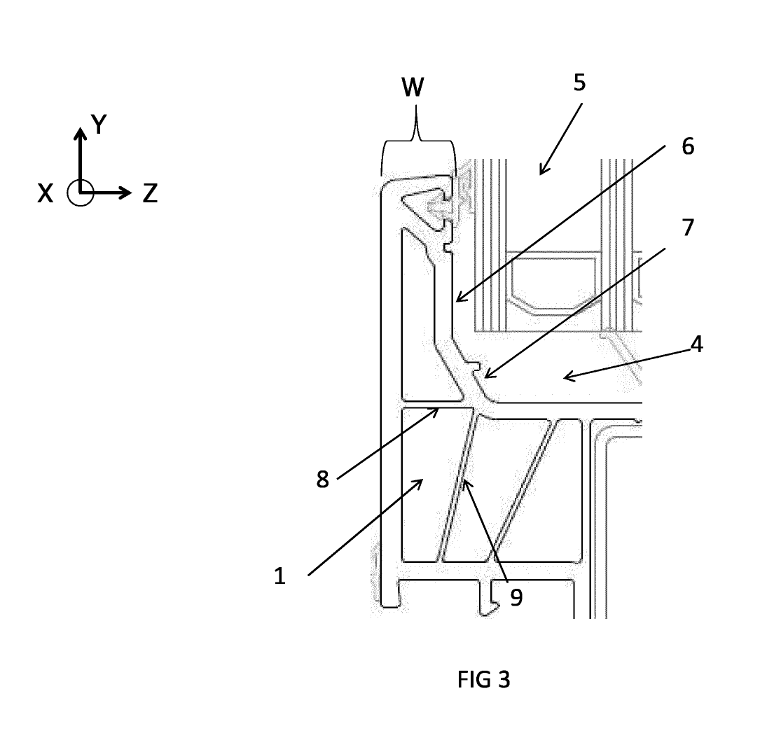

In an embodiment in accordance with the present invention as illustrated in FIG. 3, the side wall of the fixed clamping bracket facing the pane receiving zone may comprises a first section (6) at the upper portion extending in a plane generally parallel to the X-Y plane and a second section (7) connecting the first section to the surface of the main body defining the pane receiving zone, said second section extending slantingly inwards the pane receiving zone (4) towards that main body surface.

In a particular embodiment, the upper portion of the fixed clamping bracket may have a width W—measured in a direction perpendicular to the X-Y plane, of maximally 12 mm, or maximally 10 mm, preferably maximally 9 mm; and preferably a height (measured in the Y-direction from the surface of the main body delimiting the pane receiving zone to the free end of the fixed clamping bracket) over maximum width ratio of more than 2,0, preferably more than 3,0, most preferably more than 3.2.

Thanks to the inwardly slanting side wall (7) at the clamping bracket's second section, the upper portion may be of limited width without losing strength. This results in that a plastic construction profile may be obtained having a shallow fixed clamping bracket allowing manufacturing more minimalistic windows without jeopardizing strength of the profile and window assembly.

In an embodiment in accordance with the present invention, the fixed clamping bracket may have a load deflection characteristic in a direction perpendicular to the X-Y plane from inside the pane receiving zone to outwards said zone of less than 0.8 mm, preferably less than 0.7 mm, or even more preferably less than 0.65 mm (measured at the top) for a deflection load of at least 80 N/100 mm, or even for a deflection load of at least 100 N/100 mm.

By making the distance between the side walls (2′, 2″) of the fixed clamping bracket progressively widening at its base portion from the upper portion towards the main body (1), load deflection characteristics (measured at the top) may improve with at least 10%, even at least 15% compared to the load deflection characteristics of the same clamping bracket with parallel side walls.

The main body (1) of the construction profile comprises a hollow body delimited by side walls. This main body may be compartmented by inner walls in order to improve its strength and insulation characteristics. At least one inner wall thereof may extend from said second section of the side wall of the fixed clamping bracket facing the pane receiving zone in a direction perpendicular to the plane wherein said second section extends. More preferably and as also illustrated by FIG. 3, at least two inner walls (8 and 9) may extend from said second section (7) of the side wall of the fixed clamping bracket facing the pane receiving zone such that said inner side walls define a vector in a direction perpendicular to the plane wherein said second section extends. Such vector configuration provides support to the second section and helps avoiding deformation of the second section upon load, thereby increasing the overall load resistance of the fixed clamping bracket and improving keeping sufficient pressure on the pane for achieving a waterproof and wind tight connection.

Whereas conventional plastic construction profile often require an additional reinforcement profile or add-on positioned in or against the side wall of the fixed clamping bracket facing the pane receiving zone, a construction profile according to any of the above embodiments may not. This Is particularly the case for embodiments of the present invention wherein the side wall of the main body delimiting the pane receiving zone extends in a X-Z plane and, at least in the vicinity of the contact between this side wall and the base portion of the fixed clamping bracket, extends at a constant level (flat in the X-Z plane) and preferably at a level higher than (closer to the free end of the fixed clamping bracket) or at the same level as the remainder of said side wall. In other words, the base portion of the fixed clamping bracket preferably meets the surface of the main body at the shallowest (less depth) part of the pane receiving zone, meaning that no ‘drainage’ channel is provided at the interface of the main body and the fixed clamping bracket. Clearly the base portion of the clamping bracket is to be understood as not reaching to a level below the level of the side wall of the main body delimiting the pane receiving zone.

In case no drainage channel is provided in the pane receiving zone, it is preferred to provide a sealing on the side wall of the main body, reaching upwards in the Y-direction to contact the pane provided in the the pane receiving zone.

Further, a construction profile in accordance with the present invention may be used as window frame profile or door frame profile of any type, and in particular as a window wing profile.

In addition, the present invention is further directed to a window or door comprising a frame with at least one plastic construction profile as defined above, the window or door having a Resistance Class RC 2 N according to the DIN V ENV 1627/2011 standard.

Such window or door may have at least one frame side of a dimension of 0.5 m, or 1 m, or 1.5 m or more.

The present invention may also provide a window or door comprising a frame formed from a plurality of elongate plastic construction profiles as described above.

Whereas a conventional window or door comprising a frame formed conventional plastic construction profile often require an additional reinforcement profile or add-on positioned in or against the side wall of the fixed clamping bracket facing the pane receiving zone, a window or door formed from construction profiles according to any of the above embodiments may not.

In an embodiment of a window or door in accordance with the present invention, the pane side edge may be clamped between the clamping brackets such that the pane side edge surface is positioned at a distance from the surface (4) of the main body defining the pane receiving zone.

The window or door may have a depth dimension measured in a direction Z perpendicular to the X-Y plane, such that the pane is clamped in position by the clamping brackets whereby the surface of the pane (5) facing the fixed clamping bracket at least partially overlaps with the base portion (7) of the fixed clamping bracket in the depth direction.

In a window or door using the plastic construction profile as described in the above embodiments, the surface of the pane facing the outer surface of the window or door profile may be positioned at a distance of maximally 12 mm, preferably maximally 11 mm, most preferably maximally 10 mm measured in the depth direction, from the outer surface of the window or door profile.

Further, the present invention also provides a set of parts for constructing a window assembly comprising one or more elongate plastic construction profiles as described above, or one or more lengths of elongate profile frame material from which such elements may be cut, and an equal number of removable clamping brackets or one or more lengths of clamping bracket material from which such clamping brackets may be cut.

As illustrated in FIG. 2, a sealing strip is provided at the free end of the fixed clamping bracket, facing the pane positioned in the pane receiving zone. This sealing strip preferably is configured to contact the glass pane at a level as close as possible to the main body, preferably at approximately two third of the height of the fixed clamping bracket or lower, such as to limit the momentum of the pressure exerted by the pane on the fixed bracket.

The above description of the construction profile is primarily directed at a window profile, however the same is valid for sash profiles, wherein the pane receiving zone of the window profile corresponds to the window receiving zone of the sash.

1. A construction profile for a window or door frame, the profile manufactured in a plastics material and comprising:
a main body extending in a longitudinal direction X;
one fixed and one removable clamping bracket, both clamping brackets protruding from said main body in direction, Y perpendicular to the longitudinal direction X and extending parallel to one another and at a distance from one another in the longitudinal direction X;
a pane receiving zone defined by, on the one hand, said clamping brackets and, on the other hand, a surface of said main body, the receiving zone configured to receive a side edge of a pane, wherein the pane extends in an X-Y plane and is to be clamped between said clamping brackets; and
the fixed clamping bracket comprises a hollow body having at least two side walls, one facing the pane receiving zone and one facing away from the pane receiving zone and defining an upper free end portion which is configured to abut a pane received in the pane receiving zone, and a base portion joining the upper free end portion to the main body;
characterized in that the distance between said side walls of the fixed clamping bracket progressively widens at its base portion from the upper portion towards the main body.

2. The construction profile according to claim 1, wherein the side wall of the fixed clamping bracket facing the pane receiving zone comprises a first section at the upper portion extending in a plane generally parallel to the X-Y plane and a second section connecting the first section to the surface of the main body defining the pane receiving zone, said second section extending slantingly inwards to the pane receiving zone towards that main body surface.

3. The construction profile according to claim 1, wherein the upper portion of the fixed clamping bracket having a width W-measured in a direction perpendicular to the X-Y plane, of maximally 12 mm.

4. The construction profile according to claim 1, wherein the fixed clamping bracket has a load deflection characteristic in a direction perpendicular to the X-Y plane from inside the pane receiving zone to outwards said zone of less than 0.8 mm, preferably less than 0.7 mm, or even more preferably less than 0.65 mm, as measured at the top, for a deflection load of at least 80 N/100 mm, or even for a deflection load of at least 100 N/100 mm.

5. The construction profile according to claim 2, wherein the main body comprises a hollow body delimited by side walls and compartmented by inner walls, comprising at least one inner wall extending from said second section of the side wall of the fixed clamping bracket facing the pane receiving zone in a direction perpendicular to the plane wherein said second section extends.

6. The construction profile according to claim 2, wherein the main body comprises a hollow body delimited by side walls and compartmented by inner walls, comprising at least two inner walls extending from said second section of the side wall of the fixed clamping bracket facing the pane receiving zone such that said inner side walls define a vector in a direction perpendicular to the plane wherein said second section extends.

7. The construction profile according to claim 1, wherein lacking an additional reinforcement profile or add-on positioned in or against the side wall of the fixed clamping bracket facing the pane receiving zone.

8. The construction profile according to claim 1, wherein said construction profile is a window wing profile.

9. The construction profile according to claim 1, wherein a side wall of the main body delimiting the pane receiving zone extends in the X-Z plane and, at least in the vicinity of the contact between this side wall and the base portion of the fixed clamping bracket, extends at a constant level.

10. The construction profile according to claim 1, wherein the fixed clamping bracket having a height, as measured in the Y-direction from the surface of the main body delimiting the pane receiving zone to the free end of the fixed clamping bracket, over a maximum width ratio of more than 2.0, preferably more than 3.0, most preferably more than 3.2.

11. A window or door comprising a frame with at least one construction profile as defined in claim 1, the window or door having a Resistance Class RC 2 N according to the DIN V ENV 1627/201 1 standard.

12. The window or door according to claim 11 having at least one frame side of a dimension of 1 m or more.

13. The window or door according to claim 11 lacking an additional reinforcement profile or add-on positioned in or against the side wall of the fixed clamping bracket facing the pane receiving zone.

14. The window or door according to claim 11, wherein the pane side edge is clamped between the clamping brackets such that the pane side edge surface is positioned at a distance from the surface of the main body defining the pane receiving zone.

15. The window or door according to claim 10, wherein the window or door has a depth dimension measured in a direction Z perpendicular to the X-Y plane, the pane being clamped in position by the clamping brackets whereby the surface of the pane facing the fixed clamping bracket at least partially overlaps with the base portion of the fixed clamping bracket in the depth direction.

16. The construction profile according to claim 2, wherein the upper portion of the fixed clamping bracket having a width W-measured in a direction perpendicular to the X-Y plane, of maximally 12 mm.

17. The construction profile according to claim 16, wherein the fixed clamping bracket has a load deflection characteristic in a direction perpendicular to the X-Y plane from inside the pane receiving zone to outwards said zone of less than 0.8 mm, preferably less than 0.7 mm, or even more preferably less than 0.65 mm, as measured at the top, for a deflection load of at least 80 N/100 mm, or even for a deflection load of at least 100 N/100 mm.

18. The construction profile according to claim 17, wherein the main body comprises a hollow body delimited by side walls and compartmented by inner walls, comprising at least one inner wall extending from said second section of the side wall of the fixed clamping bracket facing the pane receiving zone in a direction perpendicular to the plane wherein said second section extends.

19. The construction profile according to claim 18, wherein the main body comprises a hollow body delimited by side walls and compartmented by inner walls, comprising at least two inner walls extending from said second section of the side wall of the fixed clamping bracket facing the pane receiving zone such that said inner side walls define a vector in a direction perpendicular to the plane wherein said second section extends.

20. A window or door comprising a frame with at least one construction profile as defined in claim 19, the window or door having a Resistance Class RC 2 N according to the DIN V ENV 1627/201 1 standard.
